(19) United States
(12) Patent Application Publication
(10) Pub. No.: US 2013/0196070 A1
(43) Pub. Date: Aug. 1, 2013

(54) NON-CEMENTITIOUS DRY FINISH COMPOSITIONS COMPRISING A COMBINATION OF FILM FORMING POLYMERS

(71) Applicants: Rick LeFevre, Warwick, RI (US); Chander Patil, Burlington, MA (US)

(72) Inventors: Rick LeFevre, Warwick, RI (US); Chander Patil, Burlington, MA (US)

(73) Assignee: Dryvit Systems, Inc., West Warwick, RI (US)

(21) Appl. No.: 13/817,047

(22) PCT Filed: Aug. 15, 2011
(86) PCT No.: PCT/US11/47743

§ 371 Date: Mar. 13, 2013

Related U.S. Application Data
(60) Provisional application No. 61/374,025, filed on Aug. 16, 2010.

(51) Int. Cl. C09D 5/28

(52) U.S. Cl. CPC C09D 5/28
USPC 427/385.5; 524/2

(57) ABSTRACT

Embodiments of the present invention are non-cementitious dry finish formulations that are suitable for flexible building materials and that provide a number of advantages. Such advantages include superior flexibility, ability to be pigmented to a custom color, ability to consistently provide a desired texture, increased efficiency of materials and reduction of waste.

### CROSS-REFERENCE TO RELATED APPLICATION

This application claims the benefit of U.S. Provisional Application No. 61/374,025, filed Aug. 16, 2010, the contents of which are hereby incorporated by reference in its entirety.

### BACKGROUND OF THE INVENTION

Cementitious Dry Finishes, also known as Mineral Plasters or Renders, have been used throughout Europe for decades. In the US, Cementitious Dry Finishes are commonly referred to as “Stucco”s.

The main advantage to using Cementitious Dry Finish is that the product can be shipped to a site in bags (which are easily disposed of) or sometimes hoppers. Water is added at the site and the product applied. Cement curing chemistry takes care of a sufficient cure of these systems in approximately 24 hours. Another advantage is that there is no water present in the bagged product which may be subject to freezing

Some of the drawbacks of Cementitious Dry Finishes are their 1) lack of inherent dried film flexibility, their 2) inability to be pigmented with standard alkali-sensitive colorants and their 3) tendency to effloresce. Furthermore, cementitious finishes are useful for only a 4) limited working time.

In the last decade dry polymer modification of cementitious finishes has become more popular. The main advantage of using dry polymer modification is a slight increase in the inherent dried film flexibility. Nevertheless, greater film flexibility is still desired despite these advances.

Non Cementitious Wet Finishes, also known as Synthetic Stucco or EIFS Finish (Exterior Insulated Finishing System) have been used primarily in the United States for the past four decades. The main advantages to using these finishes are the 1a) inherent dried film flexibility, the 2a) ability to pigment with standard “paint store” colorants, 3a) decreased efflorescence, and 4a) virtually unlimited working time.

Nevertheless, Non Cementitious Wet Finishes have pronounced drawbacks. In particular, Non Cementitious Wet Finishes are supplied in plastic 5 gallon buckets which are more expensive than bags to produce and have to be disposed of at increasingly higher disposal costs. Similarly, as ˜20% by weight of a Non Cementitious Wet Finish product is water and plastic (from the shipping bucket), the cost and environmental impact of these products is considerably greater (particularly as bucketed products take up more volume than bagged products in a truck).

While recent developments in dry powder chemistry have led to more flexible powders, there still remains a need for a non cement based, dry, acrylic finish which provide greater flexibility, pigmentability, and texturizing properties while minimizing waste.

### SUMMARY OF THE INVENTION

The invention is directed to novel non-cementitious dry finish formulations that are suitable for flexible building materials and that provide a number of advantages. Such advantages include superior flexibility, ability to be pigmented to a custom color, ability to consistently provide a desired texture, increased efficiency of materials and reduction of waste.

Thus, one aspect of the invention provides non-cementitious dry finish for textured building materials comprising a first spray-dried polymer, a second spray-dried polymer and at least one non-polymer component capable of providing a desired texture.

In certain aspects, at least one of the first and second spray-dried polymer is a spray-dried, film-forming polymer. In some aspects, the spray-dried, film-forming polymer is an acrylic spray-dried, film-forming polymer. In other aspects, the spray-dried, film-forming polymer is a non-acrylic, spray-dried, film-forming polymer.

In certain other aspects, at least one of the first and second spray-dried polymers is a spray-dried, non-film-forming polymer. In some aspects, the spray-dried, non-film-forming polymer is an acrylic, spray-dried, non-film-forming polymer. In other aspects, the spray-dried, non-film-forming polymer is a non-acrylic, spray-dried, non-film-forming polymer.

In still other aspects, both of the first and second spray-dried polymers are spray-dried, acrylic polymers which may be the same or different.

In yet other aspects, both of the first and second spray dried polymers are spray-dried, film-forming polymers which may be the same or different.

As used herein, two spray-dried polymers are considered “the same” if the primary component of the first polymer is the same as the primary component of the second polymer even though both polymers may comprise different additives or additional components.

In certain other aspects, the first spray-dried polymer is an acrylic polymer. In certain aspects, the first, spray-dried acrylic polymer is BASF ACRONAL S430P, BASF ACRONAL S629P, DOW DRYCRYL 2903, ELOTEX FLEX 8300, ELOTEX FLEX 8310, ELOTEX FX 7000, ELOTEX TITAN 8100 or a mixture thereof.

In still other aspects, the first spray-dried polymer is a film-forming, acrylic polymer. In certain aspects, the first spray-dried, acrylic, film forming polymer is BASF ACRONAL S430P, ELOTEX FLEX 8300, ELOTEX FLEX 8310, ELOTEX FX 7000, ELOTEX TITAN 8100 or a mixture thereof.

In certain other aspects, the second spray-dried polymer is an acrylic polymer. In certain aspects, the second, spray-dried acrylic polymer is BASF ACRONAL S430P, BASF ACRONAL S629P, DOW DRYCRYL 2903, ELOTEX FLEX 8300, ELOTEX FLEX 8310, ELOTEX FX 7000, ELOTEX TITAN 8100 or a mixture thereof.

In still other aspects, the second spray-dried polymer is a film-forming, acrylic polymer. In certain aspects, the first spray-dried, acrylic, film forming polymer is BASF ACRONAL S430P, ELOTEX FLEX 8300, ELOTEX FLEX 8310, ELOTEX FX 7000, ELOTEX TITAN 8100 or a mixture thereof.

In another aspect, the total of the first and second spray-dried polymers are from about 5% to about 95%; from about 10% to about 85%; from about 30% to about 75%; or from about 50% to about 60% of the total non-cementitious dry finish composition by weight.

In yet another aspect, the pigment volume concentration of the non-cementitious dry finish is from about 25 to about 75%; from about 40 to about 65%; or from about 50 to about 60%.

In another aspect, the invention provides a non-cementitious dry finish further comprising at least one rheological additive. In certain aspects, the at least one rheological additive is a filler. In still other aspects, the filler is a clay, a ceramic, a glass, a sand, a mineral or a combination thereof.

In yet another aspect, the invention provides a non-cementitious dry finish wherein the at least one non-polymer component provides the desired texture. Representative textures include, but are not limited to, a sandpebble texture, a sandblast texture, a freestyle finish, a quartzputzx finish, an adobe finish, a mojave finish.

In still another aspect, the invention provides a non-cementitious dry finish further comprising a dye or a pigment. In certain aspects, the dye or pigment is a dry pigment.

In still yet another aspect, the invention provides a kit for preparing a flexible building material a non-cementitious dry finish for textured building materials comprising a first film forming spray-dried polymer, a second film forming spray-dried polymer and at least one non-polymer component capable of providing a desired texture; instructions for use. In certain aspects, the invention provides a kit which further comprises a dye or other pigment. In still other aspects, the invention provides a kit which is packaged in a bag.

In yet another aspect, the invention a method of preparing a flexible building material comprising the steps of:
a. Providing a non-cementitious dry finish for textured building materials comprising a first film forming spray-dried polymer, a second film forming spray-dried polymer and at least one non-polymer component capable of providing a desired texture;
b. Reconstituting the non-cementitious dry finish; and
c. Applying the non-cementitious dry finish to a surface.

In certain aspects, the invention provides a method of preparing a flexible building material of comprising the step of:
b2. Adding a dye or other pigment to the reconstituted non-cementitious dry finish.

### DETAILED DESCRIPTION OF THE INVENTION

Non-Cementitious Dry Finishes (NCDFs)

Non-cementitious dry finishes of the invention comprise at least a first spray-dried polymer, a second spray-dried polymer and at least one non-polymer component capable of providing a desired texture.

In certain aspects, the first and second spray-dried polymers are independently acrylic or non-acrylic and may be the same or different.

Acrylic polymers capable of being formulated into NCDFs include, polymers prepared from monomers including, but not limited to, methyl acrylate, ethyl acrylate, 2-chloroethyl vinyl ether, 2-ethylhexyl acrylate, acrylic acid, methacrylic acid, methyl methacrylate, butyl methacrylate, cyclohexyl methacrylate, hydroxyethyl methacrylate, butyl acrylate, butyl methacrylate, TMPTA or mixtures. The acrylic polymers may be prepared from any known ethylenically unsaturated monomers having acrylic or methacrylic functionality using techniques known in the art. Specific Acrylic polymers capable of being formulated into NCDFs include, but are not limited to, BASF ACRONAL S430P, BASF ACRONAL S629P, DOW DLP 2001, DOW DLP 211, DOW DLP 212, DOW DLP 2120, DOW DLP 2141, DOW DLP 2151, DOW DRYCRYL 2903, ELOTEX FL1210, ELOTEX FL3200, ELOTEX FLEX 8300, ELOTEX FLEX 8310, ELOTEX FX 7000, ELOTEX FX2311, ELOTEX FX2320, ELOTEX FX2322, ELOTEX FX2700, ELOTEX FX5300, ELOTEX MP2010, ELOTEX TITAN 8100 or mixtures thereof.

Non-Acrylic polymers capable of being formulated into NCDFs may be prepared from any known ethylenically unsaturated monomers not having acrylic or methacrylic functionality, using techniques known in the art, including, but not limited to, polyvinyl acetate and styrene butadiene. Specific non-acrylic polymers capable of being formulated into NCDFs include, but are not limited to, VINAVIL 5406P, VINAVIL 5501P, VINAVIL 5603P, VINAVIL E06PA, VINAVIL T01PA, WACKER VINNAPAS 5010 N, WACKER VINNAPAS 5011 L, WACKER VINNAPAS 5012 T, WACKER VINNAPAS 5028 N, WACKER VINNAPAS 5043 N, WACKER VINNAPAS 5043 N, WACKER VINNAPAS 5044 N, WACKER VINNAPAS 5046 T or mixtures thereof.

In other aspects, the first and second spray-dried polymers are independently film forming or non-film forming and may be the same or different.

Film-forming polymers capable of being formulated into NCDFs may be any polymer capable of forming an isolable film, either itself or in the presence of a plasticizer. Such film-forming polymers can be prepared from known monomers using techniques known in the art. Specific film-forming polymers capable of being formulated into NCDFs include, but are not limited to, BASF ACRONAL S430P, DOW DLP 2001, DOW DLP 212, DOW DLP 2141, ELOTEX FLEX 8300, ELOTEX FLEX 8310, ELOTEX FX 7000, ELOTEX FX2320, ELOTEX FX2322, ELOTEX FX5300, ELOTEX MP2010, ELOTEX TITAN 8100, VINAVIL 5603P, WACKER VINNAPAS 5043 N, WACKER VINNAPAS 5044 N, WACKER VINNAPAS 5046 T or mixtures thereof.

Non-film-forming polymers capable of being formulated into NCDFs may be any polymer not capable of forming an isolable film, either itself or in the presence of a plasticizer. Such non-film-forming polymers can be prepared from known monomers using techniques known in the art. Specific non-film-forming polymers capable of being formulated into NCDFs include, but are not limited to, BASF ACRONAL S629P, DOW DLP 211, DOW DLP 2120, DOW DLP 2151, DOW DRYCRYL 2903, ELOTEX FL1210, ELOTEX FL3200, ELOTEX FX2311, ELOTEX FX2700, VINAVIL 5406P, VINAVIL 5501P, VINAVIL E06PA, VINAVIL T01PA, WACKER VINNAPAS 5010 N, WACKER VINNAPAS 5011 L, WACKER VINNAPAS 5012 T, WACKER VINNAPAS 5028 N or mixtures thereof.

In certain embodiments the total of the first and second spray-dried polymers are from about 5% to about 95%, from about 10 to about 85%, from about 30% to about 75%, from about 50 to about 60% of the total NCDF composition by weight.

In certain embodiments the total of the first and second spray-dried polymers are from about 5% to about 95%, from about 10 to about 60%, from about 15% to about 40%, or from about 17 to about 22% of the total NCDF composition by volume.

In other embodiments the ratio of the first and second spray-dried polymers is about 50:1, about 25:1; about 15:1; about 10:1; about 9:1; about 8:1; about 7:1; about 6:1; about 5:1; about 4:1; about 3:1; about 2:1; or about 1:1. In still other embodiments, the ratio of the first and second film forming polymers is from about 50:1 to about 1:1; from about 25:1 to about 2:1; from about 15:1 to about 3:1; or from about 10:1 to about 4:1.

As used herein, the term “pigment volume concentration” or “pigment binder concentration” refers to the maximum amount of a pigment which can be added or bound to a polymer composition. The pigment volume concentration is described as a percentage of the total amount of the polymer composition. Thus, in one embodiment, the pigment volume concentration is from about 25 to about 75%; from about 40 to about 65%; or from about 50 to about 60%. In other embodiments, the pigment volume concentration is about 50%; about 51%; about 52%; about 53%; about 54%; about 55%; about 56%; about 57%; about 58%; about 59%; or about 60%. In other embodiments, the pigment volume concentration is from about 1 to about 10%; from about 1.5 to about 5%; or from about 1.75 to about 2.5%.

The NCDFs of the invention may further comprise a rheological additive. As used herein a “rheological additive” or a “rheology modifier” refers to a material which modifies the flowability of the polymer composition. Such rheology modifiers include, but are not limited to, calcium or alkali salts of sulfonated lignin (such as DARACEM-19 and DARACEM-1000); hydroxylated polymers and copolymers, salts of hydroxy carboxylic acids (such as sodium citrate and sodium gluconate); salts of condensation polymers of melamine urea and melamine formaldehyde; salts of condensation polymers of sulfonate naphthalene formaldehyde (such as BOREM B-600 CNL, BOREM 100-HNL, BOREM 100-HSP); formaldehyde/urea polymers, carboxylated polyethers (such as ADVA FLOWO); and sulfonate condensation copolymers of formaldehyde and ketones; salts and condensation polymers of hydroxyethylcellulose, ethyl hydroxyethylcellulose, methylcellulose; salts and condensation polymers of polyvinyl alcohol and silane; silane polymers; calcium formate; calcium stearate; cream of tartar; hydrated lime; sodium gluconate and pyrogenic silica. Specific rheology modifiers include, but are not limited to, ASHLAND-AQUALON NATROSOL 250 HR, ASHLAND-AQUALON NATROSOL PLUS E330, BASF MELMENT F10, BOREMCO BOREM 100-HSP, DOW METHOCEL J12MS, DOW WOLFF WALOCEL MKS 10000 PF 60, DOW WOLFF WALOCEL MKX 25000 PF 25 L, DOW WOLFF WALOCEL MKX 25000 PF50L, DOW WOLFF WALOCEL MKX 25000 PP 11, DOW WOLFF WALOCEL MKX 45000 PP 10, DOW WOLFF WALOCEL MKX 6000 PF 50 L, DOW WOLFF WALOCEL MW 40000 PFV, ELOTEX BERMOCOLL E411 FQ, ELOTEX SEAL 80, WACKER HDK N 20, and WACKER HDK-H15.

The NCDFs of the invention further comprise at least one non-polymer component. In certain aspects, the non-polymer component is one or more fillers. Such fillers include, but are not limited to, extenders, clays, fillers, and aggregates including ceramics, glasses, sands, minerals or a combination thereof.

Extenders include, but are not limited to, barium sulphate, calcium carbonate, silica, aluminum silicate and mixtures thereof. Specific extenders include, but are not limited to, JM HUBER HUBERCARB G325, NYCO NYAD G, OMYA BETOCARB 17, SPECIALTY MINERALS MARBLEWHITE 200 AND US SILICA SILCOSIL 125.

Clays include, but are not limited to, kaolin, kaolinite, montmorillonite-smectite, illite, chlorite, attapulgite, varve clay, quick clay, marine clay, and mixtures thereof. Specific clays include, but are not limited to, ACTIVE MINERALS MIN-U-GEL 400, ACTIVE MINERALS MIN-U-GEL FG, HUBER KAMIN 35, HUBER KAMIN 90 and IMERYS HYDRITE FLAT D.

Aggregates include, but are not limited to, ceramic, glass, silica, alumina, grout, mica, marble, ground marble, sand, lime, calcium, aluminum and other minerals and mixtures thereof. Specific aggregates include, but are not limited to, US SILICA GROUT SAND 16, UNIMIN GRANUSIL 5020, CHEMICAL LIME 1600 and SPECIALTY MINERALS VICAL 1000.

Often, NCDFs of the invention will include more than one non-polymer component in mixtures.

NCDFs of the invention are capable of providing a textured finish. Textured finishes capable of being consistently produced using NCDFs of the instant invention include, but are not limited to, Sandpebble texture, Sandpebble fine texture, Sandblast texture, Freestyle texture, Quartzputz texture, Adobe texture and Mojave texture.

NCDFs of the invention are capable of being formulated with one or more dry pigments. Such pigments may be formulated into the NCDF prior to the addition of water by the end-user. Suitable pigments include, but are not limited to, titanium dioxide, rutile, transparent iron[II] oxide, transparent iron[III] oxide, transparent iron[II] oxide hydrate, transparent iron[III] oxide hydrate, opaque iron[II] oxide, opaque iron[III] oxide, opaque iron[II] oxide hydrate, opaque iron[III] oxide hydrate, carbon black, Perylene, quinophthalone yellow, bismuth vanadate, arylide yellow, pyrazolo quinazolone, diketo-pyrrolo-pyrrole, Naphthol AS red, diketo-pyrrolo-pyrrole, quinacridone, dioxazine violet, cobalt oxide, aluminum oxide, Co/Al oxide, Cu phthalocyanine, alpha stable, Cu phthalocyanine, beta, Cu phthalocyanine, halogenated, chromium[III] oxide or mixtures thereof. Specific Pigments include, but are not limited to, BASF XFAST BLAU 6875, DUPONT TI-PURE R-706, ELEMENTIS BLACK, HUNTSMAN TIOXIDE TR 93 and MILLENNIUM TIONA RCL-6

Non-Cementitious Dry Finishes (NCDFs)

Non-cementitious dry finishes of the invention can be prepared by conventional means. In general the polymer and non-polymer components are thoroughly mixed in a conventional dry mix blender. The blender may be a ribbon or modified ribbon style blender.

After blending, the NCDF is stored or bagged and stored for use by the end-user.

A small portion of the mixture will generally be reconstituted with water and subjected to quality control check to measures the viscosity, pH and density of the mixture.

### Specific Formulations

Specific formulations of NCDFs of the invention are described below:

Formulation A:

| | Formula | Formula |
|---|---|---|
| | Quantity | Quantity |
| Ingredient Description | Weight % | Volume % |
| Spray-dried acrylic polymer (film forming) #1 | 9.50 | 20.01 |
| Spray-dried acrylic polymer (film forming) #2 | 1.64 | 3.46 |
| Rheological Additive #1 | 0.25 | 0.52 |
| Rheological Additive #2 | 0.01 | 0.02 |
| Rheological Additive #3 | 0.07 | 0.12 |
| Rheological Additive #4 | 0.06 | 0.19 |
| Rheological Additive #5 | 0.04 | 0.04 |
| Extender | 24.05 | 20.55 |
| Clay #1 | 5.17 | 4.60 |
| Clay #2 | 0.12 | 0.12 |
| Aggregate #1 | 28.83 | 25.19 |
| Aggregate #2 | 15.19 | 13.25 |
| Aggregate #3 | 10.79 | 9.46 |
| Dry Pigment | 4.28 | 2.47 |
| | 100.000 | 100.000 |

Formulation B:

| | Formula | Formula |
|---|---|---|
| | Quantity | Quantity |
| Ingredient Description | Weight % | Volume % |
| Spray-dried acrylic polymer (film forming) #1 | 9.49 | 19.10 |
| Spray-dried acrylic polymer (film forming) #2 | 1.64 | 3.30 |
| Rheological Additive #1 | 0.30 | 0.61 |
| Rheological Additive #2 | 0.01 | 0.02 |
| Rheological Additive #3 | 0.01 | 0.02 |
| Rheological Additive #4 | 0.02 | 0.04 |
| Rheological Additive #5 | 0.04 | 0.04 |
| Rheological Additive #6 | 0.06 | 0.18 |
| Rheological Additive #7 | 0.07 | 0.11 |
| Rheological Additive #8 | 0.25 | 0.50 |
| Rheological Additive #9 | 0.64 | 1.33 |
| Rheological Additive #10 | 2.00 | 4.66 |
| Extender | 24.02 | 19.61 |
| Clay #1 | 0.12 | 0.11 |
| Clay #2 | 5.16 | 4.39 |
| Aggregate #1 | 27.54 | 23.00 |
| Aggregate #2 | 10.38 | 8.70 |
| Aggregate #3 | 14.95 | 12.46 |
| Dry Pigment | 3.30 | 1.82 |
| | 100.000 | 100.000 |

Uses

The NCDFs of the invention are capable of being used in a number of building material applications including, but not limited to, use as a construction adhesive, a sealing slurry, a render, a filling compound, a floor filling compound, a joint mortar, or a paint.

That is, the invention provides a method of preparing a flexible building material comprising the steps of:
a. Providing a non-cementitious dry finish for textured building materials comprising a first film forming spray-dried polymer, a second film forming spray-dried polymer and at least one non-polymer component capable of providing a desired texture;
b. Reconstituting the non-cementitious dry finish; and
c. Applying the non-cementitious dry finish to a surface.

In certain aspects, the invention provides a method of preparing a flexible building material of comprising the step of:
b2. Adding a dye or other pigment to the reconstituted non-cementitious dry finish.

In particular, a particular end-user will be able to reconstitute an NCDF of the invention using water, and optionally a pigment, in an appropriate amount for the desired use.

Specifically, the contents of a bag of NCDF is emptied into a >5 gallon bucket with a premeasured amount of water and “spun up” with a drill mixer equipped with a “U” paddle attachment. This is a conventional setup for mixing of cementitious systems. The amount of water is readily determined by one of skill in the art and will vary depending on the specific texture of the NCDF and the locale of the building including the climate, sun exposure and direction of the building or other material to which the NCDF is applied.

In certain embodiments, the NCDF is used directly as a finish coat for a building material. In such embodiments, the ratio of NCDF to water used to reconstitute the finish is about 50:50; about 60:40; about 70:30; about 80:20; about 90:10; about 95:5 or about 99:1. In certain embodiments, the ratio of NCDF to water used to reconstitute the finish is about 90:10; about 89:11; about 88:12; about 87:13; about 86:14; about 85:15; about 84:16; about 83:17; about 82:18; about 81:19; or about 80:20.

Kits

The invention therefore encompasses kits which, when used by the end-user, can simplify the preparation of the NCDFs of the invention for various uses and the application of the NCDF to a particular material.

A typical kit of the invention comprises an NCDF of the invention and instructions for the preparation of the NCDF (i.e. the reconstitution with water).

A typical kit of the invention comprises an NCDF packaged in a plastic bag, a paper bag, a cloth bag, a plastic pail, or a metal can.

Kits of the invention can comprise instructions for use of the NCDF as a variety of building materials including, but not limited to, use as a construction adhesive, a sealing slurry, a render, a filling compound, a floor filling compound, a joint mortar, or a paint.

Kits of the invention can further comprise dyes or pigments, particularly dry pigments which can be incorporated into the NCDF upon preparation.

### EXAMPLES

The present invention may be further illustrated by the following non-limiting examples. All reagents were used as received unless otherwise noted. Those skilled in the art will recognize that equivalents of the following supplies and suppliers exist, and as such the suppliers listed below are not to be construed as limiting.

Three non-cementitious dry finishes were formulated and labeled as follows:

### SAMPLE A—Non-cementitious Dry Finish Sandpebble DM Pastel Base

### SAMPLE B—Non-cementitious Dry Finish, Sandpebble DM Pastel Base

### COMPARATIVE SAMPLE C—Sandpebble Pastel Base

83 parts of NCDF were mixed with 17 parts of water by weight before the application.

The following tests were requested: dry time, dry and wet 180° peel adhesion, early washout, water resistance under 100% humidity, Taber abrasion, tensile bond adhesion, freeze thaw stability of the dried coating for 10 cycles, mandrel bend flexibility, and scrub resistance. Test methods were performed according to the procedures listed in the appendix.

For each property tested, relative performance of the systems is given. For example, “++” means that particular system performed very well for that particular property, while “−−” means it performed very poorly. When comparing the two NCDF samples, these results indicate that SAMPLE B performs slightly better than sample SAMPLE A for early washout, low temperature cured dry and wet scrub resistance, freeze thaw stability, and wet peel adhesion. Wet finish sample COMPARATIVE SAMPLE C performed best out of all three samples for most of the tested properties.

| | Drying | Washout | | | | | | | |
|---|---|---|---|---|---|---|---|---|---|
| | Time | 75° F. | 40° F. | Water | | | | | Water |
| | 75° F. | 50% | 50% | Resistance | Taber | Tensile | Freeze | Mandrel | Absorption |
| | 50% RH | RH | RH | 100% RH | Abrasion | Bond | Thaw | Bend | %, 7 Days |
| A | = | − | −− | = | = | = | −− | = | = |
| B | = | − | − | = | = | = | − | = | = |
| C | = | + | + | = | + | = | + | − | − |

| | |
|---|---|
| Peel Adhesion, | Peel Adhesion, |
| 7 Days 75° F./50% RH, | 7 Days 40° F./50% RH, |
| Cured | Cured |

| | | Wet, | | Wet, |
|---|---|---|---|---|
| | Dry | 3 Hr Fog Box | Dry | 3 Hr Fog Box |
| A | ++ | − | = | −− |
| B | = | − | = | − |
| C | = | + | + | + |

| | |
|---|---|
| Scrub, 24 Hours cured | Scrub, 7 Days cured |

| | 75 F./50% RH | 40 F./50% RH | 75 F./50% RH | 40 F./50% RH |
|---|---|---|---|---|
| SAMPLE A | − | −− | − | −− |
| SAMPLE B | + | − | + | − |
| COMPARATIVE | ++ | + | ++ | + |
| SAMPLE C | | | | |

### Detailed Data:

### Dry Time

Condition: All the submitted samples and substrates were equilibrated in a 75° F./50% RH room before testing. Samples were troweled to 1/16″ thick over base coat with embedded mesh (over EPS foam) and tested according to ASTM D1640 for “Set-To-Touch Time”, “Dry-To-Touch Time”, “Dry-Hard Time”, and “Dry-Through Time”. Time was recorded in minutes in Table 1. Overall, the samples had similar dry times.

TABLE 1
Dry Time Results

| | Drying Time | | | |
|---|---|---|---|---|
| | Set-To- | Dry-To- | | |
| | Touch, | Touch, | Dry-Hard, | Dry-Through, |
| SAMPLE ID | Min | Min | Min | Min |
| SAMPLE A | 35 | 50 | 135 | 210 |
| SAMPLE B | 30 | 45 | 150 | 225 |
| COMPARATIVE | 30 | 45 | 135 | 225 |
| SAMPLE C | | | | |

### 180° Peel Adhesion

Rohm and Haas Test Method TM-903: Adhesion was tested using a dry and wet peel adhesion test (refer to ASTM C-784). Plywood Blocks (previously coated with basecoat with embedded mesh) were coated with aggregate finish to 1/16″ thickness and a 1″×14″ standard glass fiber mesh was immediately embedded to the finish in a way that 3″ mesh was hanging over the edge of the block. Samples were cured for 7 days at 75° F./50% RH or 40° F./50% RH prior to peel adhesion testing. During this test, the force to peel the mesh from the coating at a 180° angle was measured by Tinius Olsen at the rate of 2.0″/min For wet peel adhesion testing, samples were placed in a fog box for three hours before testing. Three replicates for each sample were tested for both the dry and wet conditions. The results are calculated in pounds per linear inch (PLI). For the samples cured at 75° F., failure occurred between the mesh and the finish, while for samples cured at 75° F., samples failed cohesively within the finish. Note that the wet peel adhesion of sample AA (cured at 40° F.) could not be measured because the mesh detached from the substrate upon exposure in the fog box.

TABLE 2
Dry and Wet Peel Adhesion Results

| | Dry Peel Adhesion, | | | | | 3 hrs in Fog Box | | | | |
|---|---|---|---|---|---|---|---|---|---|---|
| | pli | | | | Failure | Wet Peel Adhesion, pli | | | | Failure |
| Sample | A | B | C | Average | Mode | A | B | C | Average | Mode |
| | 7 Days cured at 75° F./50% RH | | | | | | | | | |
| SAMPLE A | 15.5 | 13.5 | 14.5 | 14.5 | C | 0.4 | 0.3 | 0.39 | 0.36 | C |
| SAMPLE B | 11.0 | 11.0 | 9.5 | 10.8 | C | 0.91 | 0.86 | 0.54 | 0.77 | C |
| COMPARATIVE | 9.0 | 9.5 | 9.5 | 9.3 | C | 2.7 | 2.8 | 2.8 | 2.77 | C |
| SAMPLE C | | | | | | | | | | |
| | 7 Days cured at 40° F./50% RH | | | | | | | | | |
| SAMPLE A | 7.25 | 6.50 | 7.20 | 6.98 | C | — | — | — | — | — |
| SAMPLE B | 10.75 | 8.00 | 7.00 | 8.58 | C | 0.20 | 0.19 | 0.15 | 0.18 | C |
| COMPARATIVE | 11.00 | 11.50 | 9.25 | 10.58 | C | 0.90 | 0.88 | 0.90 | 0.89 | C |
| SAMPLE C | | | | | | | | | | |

### Washout Resistance of Finishes

Conditions: Rohm and Haas Test Method #908. The washout test simulates how the coatings will perform under moderate rainfall after short cure time (24 hr.). Samples were applied to a thickness of 1/16″ on a cementitious base coat with mesh over EPS foam and then cured for 24 hours at two separate conditions: 1) 75° F. and 50% RH and 2) 40° F. and 50% RH. Samples were then tested under running water, 180 gallons/hour spray rate.

The results for washout resistance are shown in Table 3. When cured at the higher temperature, all samples passed the washout resistance test except slight early surface erosion. When cured at the lower temperature, all samples passed the test except SAMPLE A. Sample COMPARATIVE SAMPLE C, control performed best for washout for both cure conditions.

TABLE 3
Test Results for Washout Resistance

| | 24 HRS 75° F. | 24 HRS 40° F. |
|---|---|---|
| SAMPLE ID | (7 hr. water spray) | (3 hr. water spray) |
| SAMPLE A | Erosion began at 5 min; | Immediate erosion; |
| | did not wear | wore through to |
| | through to basecoat | basecoat at 1.5 min |
| SAMPLE B | Erosion began at 5 min; | Erosion began at 1 min; |
| | did not wear through | did not wear through |
| | to basecoat | to basecoat |
| COMPARATIVE | Pass (no erosion) | Pass (no erosion) |
| SAMPLE C | | |

### Water Resistance to 100% RH (Modified ASTM-2247-92)

Conditions: Pieces of 6″×6″ EPS with cementitious base coat (mesh embedded) were used for this test. All submitted samples were applied onto the cementitious base coat to 1/16″ thick. Samples were cured for 7 days at 75° F. and 50% relative humidity. Samples were exposed to Cleveland Cabinet in way that finishes were facing toward to the heated water (water temperature was set to 100 F) and back of the samples were covered with aluminum foil so that the vapor would not escape. The samples were tested for 14 days in the 100% humidity Cleveland Cabinet and rated for blistering, rusting, and cracking.

Table 4 shows that all samples passed the 100% humidity exposure test.

TABLE 4
Water Resistance to 100% RH

| SAMPLE ID | Test Result |
|---|---|
| SAMPLE A | Pass |
| SAMPLE B | Pass |
| COMPARATIVE | Pass |
| SAMPLE C | |

### Taber Abrasion Resistance

Samples were troweled 1/16″ thick to 4″×12″ Q Aluminum panels. The prepared panels were then allowed to dry in the (CTR; 72° F., 50% relative humidity) for 14 days prior to abrasion resistance testing. Each panel was cut into two 4″×4″ squares, and a ¼″ hole was drilled into the center of each square. Each panel was weighed initially (to the nearest 0.1 mg) and then run on a Model 5130 Taber Abraser for 500 cycles. H-22 wheels were used, with a 500-gram weight added to each wheel. Resurfacing was performed with S-11 abrasive disks after every 500 revolutions. After the given number of cycles (500), all of the loose abraded particles were removed and the sample was reweighed. The weight loss was then calculated for the sample. Two replicate tests were performed for each sample.

Table 5 shows the average weight loss abraded after 500 cycles of abrasion testing. Two samples were tested to compare the abrasion resistance of each finish. Both samples SAMPLE A and SAMPLE B had comparable abrasion while COMPARATIVE SAMPLE C had the best abrasion resistance out of all three samples.

TABLE 5
Taber Abrasion Data after 500 Cycles on the Taber Abraser

| | Taber Abrasion | | Average | |
|---|---|---|---|---|
| Sample | Wt Loss, g | | Wt Loss, g | St. Dev |
| SAMPLE A | 1.2566 | 1.1738 | 1.2152 | 0.06 |
| SAMPLE B | 1.2085 | 1.0789 | 1.1437 | 0.09 |
| COMPARATIVE | 0.9521 | 0.9519 | 0.9520 | 0.00 |
| SAMPLE C | | | | |

### Tensile Bond

Condition: Rohm and Haas Test Method #901 was used to measure tensile bond adhesion. 1/16″ thick topcoat aggregate finishes were applied over the 2″×2″ EPS foam, which was previously coated with reinforced cement basecoat. The samples were cured at 75° F./50% RH room for 26 days. 2″×2″ plywood pieces were then glued onto the surface of the finishes using a two-part epoxy. Samples were cured for 48 hours before testing the tensile bond adhesion. Three replicates of each sample were tested at the speed of 0.110″ per minute using a Tinius Olsen tester. Data is shown below in Table 6. All failure occurred cohesively in the EPS layer.

TABLE 6
Tensile Bond Test Results
Results in psi

| SAMPLE ID | 1 | 2 | 3 | Average, psi | Failure Mode |
|---|---|---|---|---|---|
| SAMPLE A | 27.5 | 22.5 | 22.5 | 24.3 | Inside EPS |
| SAMPLE B | 24.6 | 24.2 | 22.4 | 23.7 | Inside EPS |
| COMPARATIVE | 21.6 | 19.5 | 18.7 | 19.9 | Inside EPS |
| SAMPLE C | | | | | |

### Freeze/Thaw Resistance

Condition: ASTM E2485 Method B was used to perform this test. Five 3″×6″ EIFS samples were prepared at 1/16″thick on cementitious basecoat (with reinforcing mesh) atop one-inch thick EPS. Samples were cured at 75° F. and 50% RH for 28 days. The edges and the back of each sample were sealed with impervious wax before testing for freeze/thaw. One sample was kept at room temperature (retain sample) and the remaining four samples of each set were tested for freeze thaw. The finish sides of each sample were submerged in the water for 8 hours +/−½ hour. Then the samples were pulled out from water and placed in a rack, in a way that each samples were separated from each other, and then the rack was kept in the freezer for 16 hours +/−½ hour. This process counted as one cycle. Samples were evaluated for cracking, checking, crazing, erosion, rusting, peeling, and blistering throughout the cycling process. Samples were tested for 10 cycles.

Table 7 shows that all samples passed 10 cycles of freeze/thaw. Both SAMPLE A and SAMPLE B showed a fair amount of surface erosion, with sample AA being slightly worse. Sample COMPARATIVE SAMPLE C showed no deleterious effects after 10 freeze/thaw cycles.

TABLE 7
Freeze/thaw Test Results

| | Freeze/Thaw Resistance | | | | | | | |
|---|---|---|---|---|---|---|---|---|
| SAMPLE ID | Cracking | Checking | Erosion | Rusting | Blistering | Peeling | Crazing | Delamination |
| SAMPLE A | 10 | 10 | 5 | 10 | 10 | 10 | 10 | 10 |
| SAMPLE B | 10 | 10 | 6 | 10 | 10 | 10 | 10 | 10 |
| COMPARATIVE | 10 | 10 | 10 | 10 | 10 | 10 | 10 | 10 |
| SAMPLE C | | | | | | | | |

10 = Best,
1 = Poor

### Mandrel Bend Flexibility

Condition: Rohm and Haas Test Method #915. Samples were prepared at 1/16″ thick on 12″×4″ Aluminum Q panels and cured for one week at 75° F. and 50% relative humidity. The Mandrel Bend flexibility test was performed at three different temperatures (75° F., 40° F., and 0° F.) using mandrels of different sizes. The samples were equilibrated at the required temperatures for four hours before testing. The test involves bending the coated panel over the mandrel starting with the largest diameter and working down to the smallest and noting the smallest diameter at which the coating does not crack.

Mandrel Bend test results are shown below in Table 8. Samples A and B had similar flexibility at all three temperatures and more flexible than sample C.

TABLE 8
Mandrel Bend Test Results

| SAM- | 75° F. | | | 40° F. | | | 0° F. | | |
|---|---|---|---|---|---|---|---|---|---|
| PLE ID | 4″ | 2″ | 1″ | 4″ | 2″ | 1″ | 4″ | 2″ | 1″ |
| SAM- | Pass | Pass | Fail | Pass | Pass | Fail | Pass | Fail | — |
| PLE A | | | | | | | | | |
| SAM- | Pass | Pass | Fail | Pass | Fail | — | Pass | Fail | — |
| PLE B | | | | | | | | | |
| COMPA- | Pass | Fail | — | Pass | Fail | — | Fail | — | — |
| RATIVE | | | | | | | | | |
| SAM- | | | | | | | | | |
| PLE C | | | | | | | | | |

### Scrub Resistance (Wet Abrasion Resistance)

Conditions: Rohm and Haas Test Method #909. Samples were coated onto black vinyl Leneta Chart at 1/16″ thick and cured at four different conditions, 1) 24 hrs at 75° F./50% RH, 2) 24 hrs at 40° F./50% RH, 3) 7 days at 75° F./50% RH, and 4) 7 days at 40° F./50% RH before testing. Byk Gardner Abrasion Testers were used to perform this test. Each sample was tested to 2000 cycles unless failure occurred before 2000 cycles. Ten grams of Scrub Medium soap was applied every 500 cycles. Samples were weighed before and after testing to allow for calculation of weight loss. The average of three samples is reported in Table 9 below as percent and gram weight loss and # of cycles.

The data in Table 9 shows the scrub resistance for all four cure conditions.

Statistical analysis shows that samples of a given formulation perform the same after 24 hours cure as they do after 7 days cure (3<0.05 as statistically significant).

Sample A had more weight loss vs. samples B and C at all conditions (p<0.05).

Samples B=sample C for 24 hours (for both room temperature and 40 F cure), but sample B had more weight loss vs. sample C at 7 days (for both 75° F. and 40° F. cure), (p<0.05).

TABLE 9
Test Results for Scrub Resistance

| SAMPLE ID | Wt Loss, % | Wt Loss, g | # Cycles |
|---|---|---|---|
| | Samples cured 24 hrs @ 75° F. & 50% RH | | |
| SAMPLE A | 7.84 | 3.80 | 2000 |
| SAMPLE B | 2.22 | 1.08 | 2000 |
| COMPARATIVE | 0.83 | 0.37 | 2000 |
| SAMPLE C | | | |
| | Samples cured 24 hrs @ 40° F. & 50% RH | | |
| SAMPLE A | — | — | 80 |
| SAMPLE B | 15.56 | 7.03 | 2000 |
| COMPARATIVE | 4.35 | 1.98 | 2000 |
| SAMPLE C | | | |
| | Samples cured 7 Days @ 75° F. & 50% RH | | |
| SAMPLE A | 12.47 | 5.66 | 2000 |
| SAMPLE B | 3.07 | 1.32 | 2000 |
| COMPARATIVE | 0.56 | 0.25 | 2000 |
| SAMPLE C | | | |
| | Samples cured 7 Days @ 40° F. & 50% RH | | |
| SAMPLE A | — | — | 24 |
| SAMPLE B | 10.15 | 5.15 | 2000 |
| COMPARATIVE | 2.27 | 1.12 | 2000 |
| SAMPLE C | | | |

### Water Absorption

Conditions: Rohm and Test Method #906. Samples were prepared on the release paper at 1/16″thick. Samples were peeled off from the release paper after 14 days and dried upside-down for another 14 days. Samples were cured at 75° F. and 50% RH. One inch squares of free samples were cut in triplicate and submerged into DI water. Samples were taken out from the water and excess water was blotted using absorbent paper. The samples were then weighed using an analytical balance. Measurements of % water absorption were taken at various timepoints (see Table 10 below). The average (of the three replicates) water absorption, in percent is reported.

TABLE 10
Water Absorption Test Results
% Water Absorption, average of 3 samples

| SAMPLE ID | 4 Hrs | 8 Hrs | 24 Hrs | 72 Hrs | 7 Days |
|---|---|---|---|---|---|
| SAMPLE A | 8.5 | 8.0 | 7.6 | 6.7 | 6.4 |
| SAMPLE B | 6.6 | 6.6 | 6.3 | 6.5 | 8.2 |
| COMPARATIVE | 10.7 | 9.9 | 8.1 | 7.2 | 9.5 |
| SAMPLE C | | | | | |

### APPENDIX A

### Test Methods Used for this Project

### [Rohm and Haas Company Test Method #908: “Washout Resistance.”

No ASTM Standard. Brief description: Variably cured (time/temp/humidity) EIFS finishes are subjected to running water (streamed or sprayed) and relatively graded.

### Rohm and Haas Company Test Method #909: “Scrub Resistance.”

No ASTM standard. Brief description: Variably cured (time/temp/humidity) EIFS finishes are subjected to 2000 cycle Gardner Abrasion Tester and relatively graded.

ASTM Test Method D-1640: “Drying Time.”

ASTM Test Method E-2485: “Standard Test Method for Freeze/Thaw Resistance of Exterior Insulation and Finish Systems (EIFS) and Water Resistive Barrier Coatings”; Method B.

### Rohm and Haas Company Test Method #904: “180° Peel Adhesion.”

(modified ASTM C794). Brief Description: Variably cured (time/temp/humidity) EIFS finishes are subjected to 180 peel, with mesh embedded finish from basecoat as substrate.

Rohm and Haas Company Test Method #906: “Water Absorption/Water Swelling.”

No ASTM standard. Brief description: 2 week cured free finish films are soaked in water for 24 hours and the % water weight pickup is recorded.

### Rohm and Haas Company Test Method #914: “Taber Abrasion.”

No ASTM Standard. Brief Description: 1 week cured EIFS finishes are subjected to a Taber Abraser Model 5130 and cycles to fail or weight loss after 500 cycles are recorded.

### Rohm and Haas Company Test Method #915: “Mandrel Bend.”

No ASTM Standard. Variably cured (time/temp/humidity) EIFS finishes on 1″ wide aluminum panels are bent over mandrels at room temp, 32 F and 0 F. The mandrel diameters at which cracking developed is recorded.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. The contents of all references, issued patents, and published patent applications cited throughout this application are hereby incorporated by reference.

1. A non-cementitious dry finish for textured building materials comprising a first spray-dried polymer, a second spray-dried polymer and at least one non-polymer component capable of providing a desired texture.

2. The non-cementitious dry finish of claim 1, wherein at least one of the first and second spray-dried polymers is a spray-dried, film-forming polymer.

3. The non-cementitious dry finish of claim 2, wherein the spray-dried, film-forming polymer is an acrylic polymer.

4. The non-cementitious dry finish of claim 2, wherein the spray-dried, film-forming polymer is a non-acrylic polymer.

5. The non-cementitious dry finish of claim 1, wherein at least one of the first and second spray-dried polymers is a spray-dried, non-film-forming polymer.

6. The non-cementitious dry finish of claim 5, wherein the spray-dried, non-film-forming polymer is an acrylic polymer.

7. The non-cementitious dry finish of claim 5, wherein the spray-dried, non-film-forming polymer is a non-acrylic polymer.

8. The non-cementitious dry finish of claim 1, wherein both of the first and second spray dried polymers are spray-dried, acrylic polymers which may be the same or different.

9. The non-cementitious dry finish of claim 1, wherein both of the first and second spray dried polymers are spray-dried, film-forming polymers which may be the same or different.

10. The non-cementitious dry finish of claim 1, wherein the first spray-dried polymer is an acrylic polymer and is BASF ACRONAL S430P, BASF ACRONAL S629P, DOW DRYCRYL 2903, ELOTEX FLEX 8300, ELOTEX FLEX 8310, ELOTEX FX 7000, ELOTEX TITAN 8100 or a mixture thereof.

11. The non-cementitious dry finish of claim 1, wherein the first spray-dried polymer is a film-forming, acrylic polymer and is BASF ACRONAL S430P, ELOTEX FLEX 8300, ELOTEX FLEX 8310, ELOTEX FX 7000, ELOTEX TITAN 8100 or a mixture thereof.

12. The non-cementitious dry finish of claim 1, wherein the second spray-dried polymer is an acrylic polymer and is BASF ACRONAL S430P, BASF ACRONAL S629P, DOW DRYCRYL 2903, ELOTEX FLEX 8300, ELOTEX FLEX 8310, ELOTEX FX 7000, ELOTEX TITAN 8100 or a mixture thereof.

13. The non-cementitious dry finish of claim 1, wherein the first spray-dried polymer is a film-forming, acrylic polymer and is BASF ACRONAL S430P, ELOTEX FLEX 8300, ELOTEX FLEX 8310, ELOTEX FX 7000, ELOTEX TITAN 8100 or a mixture thereof.

14. The non-cementitious dry finish of claim 1, wherein the total of the first and second spray-dried polymers are from about 5% to about 95% of the total composition by weight.

15-17. (canceled)

18. The non-cementitious dry finish of claim 1, wherein the total of the first and second spray-dried polymers are from about 5% to about 95% of the total composition by volume.

19-20. (canceled)

21. The non-cementitious dry finish of claim 1, wherein the total of the first and second spray-dried polymers are from about 17% to about 22% of the total composition by volume.

22. The non-cementitious dry finish of claim 1, wherein pigment volume concentration is from about 25 to about 75%

23-27. (canceled)

28. The non-cementitious dry finish of claim 1, further comprising at least one rheological additive.

29. The non-cementitious dry finish of claim 1, wherein the at least one non-polymer component is a filler.

30. The non-cementitious dry finish of claim 17, wherein the at least one filler is a clay, a ceramic, a glass, a sand, a mineral or a combination thereof.

31. The non-cementitious dry finish of claim 1, wherein the at least one non-polymer component provides a Sandpebble texture, a Sandpebble fine texture, a Sandblast texture, a Freestyle texture, A Quartzputz texture, an Adobe texture, a Mojave texture.

32. The non-cementitious dry finish of claim 1, further comprising a pigment.

33. A kit for preparing a flexible building material comprising a non-cementitious dry finish of claim 1; and instructions for use.

34. The kit for preparing a flexible building material of claim 21 further comprising a dye or other pigment.

35. (canceled)

36. A method of preparing a flexible building material comprising the steps of:
a. Providing a non-cementitious dry finish of claim 1;
b. Reconstituting the non-cementitious dry finish; and
c. Applying the non-cementitious dry finish to a surface.

37. The method of preparing a flexible building material of claim 36 further comprising the step of:
b2. Adding a dye or other pigment to the reconstituted non-cementitious dry finish.
